(19) United States
(12) Patent Application Publication
(10) Pub. No.: US 2025/0282070 A1
(43) Pub. Date: Sep. 11, 2025

(54) ELECTRIC SHAVER

(71) Applicant: MAXELL IZUMI CO., LTD., Matsumoto-shi (JP)

(72) Inventor: Toshihiko OHARA, Matsumoto-shi (JP)

(21) Appl. No.: 19/045,556

(22) Filed: Feb. 5, 2025

(30) Foreign Application Priority Data
Mar. 11, 2024 (JP) 2024-037508

(51) Int. Cl. B26B 19/26; B26B 19/06

(52) U.S. Cl. CPC B26B 19/26; B26B 19/06

(57) ABSTRACT

An electric shaver includes a main body including a rotary-type blade unit having a first outer blade and a first inner blade rotating while coming into sliding contact with the inner surface, a reciprocating-type blade unit having a curved arc-shaped second outer blade and a second inner blade reciprocating while coming into sliding contact with the inner surface, and a motor. The reciprocating-type blade unit is provided in the main body such that the second outer blade is movable upward and downward. In the rotary-type blade unit, an upper surface of the first outer blade is inclinable to a position parallel to tangent planes in contact with a farthest portion from the second outer blade on the upper surface and an upper surface of the second outer blade.

### CROSS-REFERENCE TO RELATED APPLICATION

This application is based upon and claims the benefit of priority of the prior Japanese Patent Application No. P2024-037508, filed on Mar. 11, 2024, and the entire contents of which are incorporated herein by reference.

### TECHNICAL FIELD

The present invention relates to an electric shaver.

### BACKGROUND ART

Electric shavers in the related art are mainly classified into a rotary-type electric shaver including a rotary-type blade unit and a reciprocating-type electric shaver including a reciprocating-type blade unit (may be referred to as a foil blade unit in some cases). In addition, electric shavers including both the blade units have also been developed (PTL 1: JP-A-2013-070749).

### SUMMARY OF INVENTION

### Technical Problem

As in an example disclosed in PTL 1, the rotary-type electric shaver generally has a characteristic that deep shaving is difficult although long hairs or curled hairs are easily shaved. On the other hand, the reciprocating-type electric shaver has a characteristic that deep shaving is easy although the long hairs or the curled hairs are less likely to be shaved. Therefore, the electric shaver disclosed as an example in PTL 1 includes both the rotary-type blade unit and the reciprocating-type blade unit, and aims to take advantages of both the blade units.

However, as a result of intensive studies, the present inventors have obviously found the followings. When the electric shaver simply includes both the rotary-type blade unit and the reciprocating-type blade unit, there is a problem in that the hairs cannot be sufficiently shaved on sites such as a face having a complicated shape, a portion under a chin on the periphery (around a neck), and a portion under a nose. Specifically, unshaven areas appear in particularly long hairs or curled hairs, thereby causing a problem in that deep shaving is not available and a cleanly finished state is not realized.

### Solution to Problem

The present invention is made in view of the above-described circumstances, and an object of the present invention is to provide an electric shaver which can prevent particularly long hairs or curled hairs from being unshaven, for a face having a complicated shape and peripheral sites, and which can realize a cleanly finished state by enabling uniform deep shaving to be performed on an entire surface of a shaving target site. In this invention, examples of the hairs include beards, mustache, whisker, and the like.

An electric shaver according to an embodiment includes a main body including a rotary-type blade unit having a first outer blade having an annular shape or a disk shape, and a first inner blade rotating while coming into sliding contact with an inner surface of the first outer blade, a reciprocating-type blade unit having a second outer blade having a curved arc shape, and a second inner blade reciprocating while coming into sliding contact with an inner surface of the second outer blade, and a motor. The reciprocating-type blade unit is provided in the main body such that the second outer blade is movable upward and downward. Even in a case where a top portion of the second outer blade is located at any position, the rotary-type blade unit is provided in the main body such that an upper surface of the first outer blade is inclinable to a position parallel to a tangent plane in contact with a farthest portion from the second outer blade on the upper surface of the first outer blade and an upper surface of the second outer blade.

According to this configuration, a close contact property in which the outer blade comes into close contact with a face having a complicated shape and peripheral sites can be improved, the long hairs or the curled hairs can be prevented from being unshaven, and uniform deep shaving can be performed.

For example, a configuration may be adopted in which the rotary-type blade units are provided in two sets, and are disposed such that a line connecting respective centers of the two sets in a plan view is parallel to a longitudinal direction of the reciprocating-type blade unit.

For example, a configuration may be adopted in which the reciprocating-type blade units are provided in two sets, and are disposed in series such that respective center lines of the two sets in a longitudinal direction in a plan view are located on the same line.

It is preferable that the electric shaver further includes a flexible arm that transmits a driving force of the motor to the first inner blade.

### Advantageous Effects of Invention

According to the present invention, the close contact property of the outer blade can be improved for the face having a complicated shape and peripheral sites. In particular, long hairs or curled hairs can be prevented from being unshaven, and a cleanly finished state can be realized by enabling uniform deep shaving to be performed on an entire surface of a shaving target site.

### BRIEF DESCRIPTION OF DRAWINGS

FIG. 1 is a schematic view (perspective view) illustrating an example of an electric shaver according to a first embodiment of the present invention.

FIG. 2 is a schematic view (exploded perspective view) illustrating an example of a drive mechanism of the electric shaver illustrated in FIG. 1.

FIG. 3 is a schematic view (perspective view) illustrating an example of an outer blade and an inner blade of a rotary-type blade unit of the electric shaver illustrated in FIG. 1.

FIG. 4 is a schematic view (perspective view) illustrating an example of an outer blade and an inner blade of a reciprocating-type blade unit of the electric shaver illustrated in FIG. 1.

FIGS. 5A to 5C are views for describing operations of the rotary-type blade unit and the reciprocating-type blade unit of the electric shaver illustrated in FIG. 1.

FIG. 6 is a view for describing a usage state of the electric shaver illustrated in FIG. 1.

FIGS. 7A and 7B are views for describing a usage state of the electric shaver illustrated in FIG. 1.

FIGS. 8A and 8B are views for describing a usage state of the electric shaver illustrated in FIG. 1.

FIG. 9 is a schematic view (perspective view) illustrating another example of the electric shaver according to the first embodiment of the present invention.

FIG. 10 is a schematic view (side view) illustrating an example of an electric shaver according to a second embodiment of the present invention.

### DESCRIPTION OF EMBODIMENTS

### First Embodiment

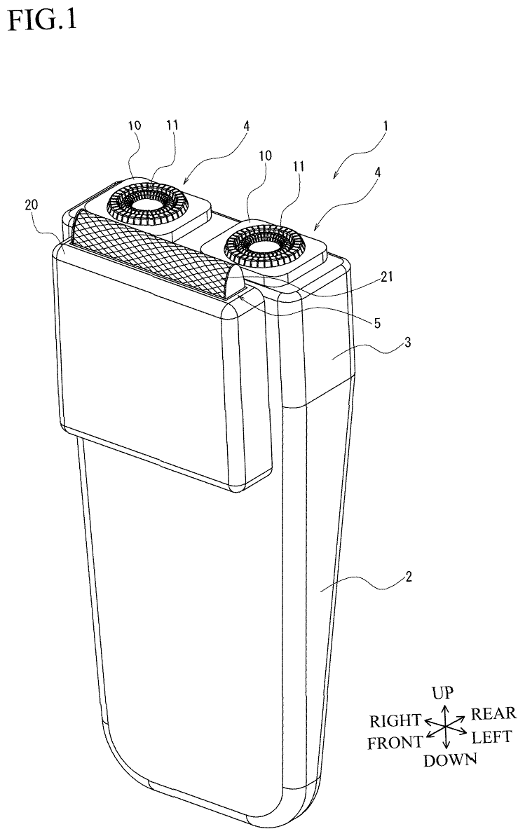

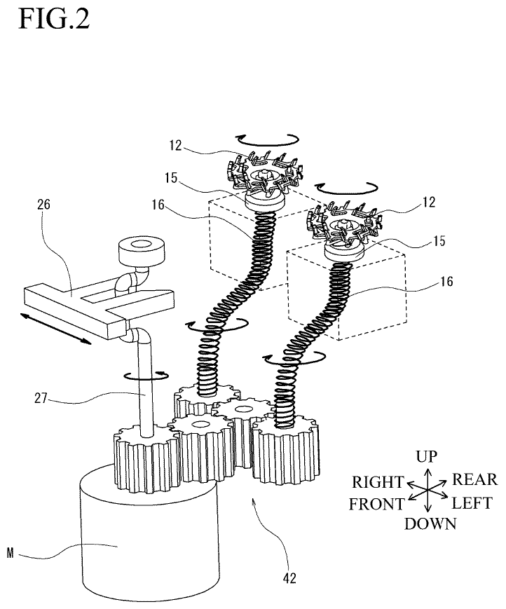

Hereinafter, a first embodiment of the present invention will be described in detail with reference to the drawings. FIG. 1 is a schematic view (perspective view) illustrating an example of an electric shaver 1 according to the present embodiment. In addition, FIG. 2 is a schematic view (exploded perspective view) illustrating an example of a drive mechanism of the electric shaver 1. For convenience of description, an arrow may indicate an upward, downward, leftward, rightward, forward, or rearward direction in the drawing in some cases. In all drawings for describing the embodiment, the same reference numerals will be assigned to members having the same function, and repeated description thereof may be omitted in some cases.

The electric shaver 1 according to the present embodiment includes a main body 2. In addition, an upper portion of the main body 2 is configured as a head unit 3 (in the present application, the term “main body” may be used as a general term including the head unit in some cases). The head unit 3 may be configured to be integrally provided with the main body 2 to be unable to swing as illustrated in FIG. 1, or may be configured to be separately provided to be able to swing with respect to the main body 2 (not illustrated).

Inside the main body 2, a motor M (one in the present embodiment) that drives an inner blade (to be described later), a battery (not illustrated) that supplies power to the motor M, and a control unit (not illustrated) that performs a series of control such as rotational driving of the motor M are provided. The above-described battery may be configured to use either a storage battery or a dry battery. In addition, a switch (not illustrated) for turning on and off power supply or the like is provided on a front surface of the main body 2.

On the other hand, a plurality of blade units are provided in the head unit 3. As an example, two sets (one set or three or more sets may be used) of rotary-type blade units 4 and one set (two or more sets may be used) of reciprocating-type blade units 5 are provided. The reciprocating-type blade unit 5 may have a structure in which the reciprocating-type blade unit 5 is supported at a position lower than the head unit 3 in the main body 2 (not illustrated).

Specifically, as illustrated in FIG. 1, the two sets of rotary-type blade units 4 are provided such that first outer blades 11 (to be described later) forming the unit have the same diameter and include the upper surfaces having the same height, and are disposed such that a line connecting respective centers of the two sets in a plan view is parallel to a longitudinal direction (reciprocating direction of a second inner blade 22 (to be described later)) of the reciprocating-type blade unit 5. In addition, a set of reciprocating-type blade units 5 is provided such that a second outer blade 21 (to be described later) forming the unit has an approximate length extending over both ends of the two first outer blades 11.

First, the rotary-type blade unit 4 will be described. The rotary-type blade unit 4 according to the present embodiment includes an annular (may be either one row, or two or more rows) first outer blade 11 and a first inner blade 12 rotating while coming into sliding contact with an inner surface of the first outer blade 11. The first outer blade may have a disk shaped-configuration (so-called dome shape) (not illustrated).

In addition, the first outer blade 11 and the first inner blade 12 are attached to a blade frame 10 in a state of being combined with each other. Furthermore, the blade frame 10 is attached to the head unit 3 to be swingable forward, rearward, leftward, and rightward directions and movable upward and downward via a spring member (not illustrated) or the like.

The first outer blade 11 according to the present embodiment is formed as an integrated structure by performing processing such as die cutting, squeezing, and bending through press working by using a flat plate-shaped metal material having a predetermined thickness (relatively thicker than the second outer blade 21 (to be described later)) made of a stainless steel alloy or the like. The first outer blade 11 has a substantially cup shape in which a peripheral edge is bent downward. In addition, many hair inlets 13 through which the hairs enter are formed to penetrate an outer surface, that is, from an upper surface 11a to a portion of a side surface 11b (may be only the upper surface 11a) (for simplification of the drawing, reference numerals are assigned only to some of the hair inlets 13). In this manner, an operation is obtained to cut the hairs entering the hair inlets 13 by pinching the hairs between a lower end portion and a tip portion of the first inner blade 12 (a small blade 14) (to be described later). The hair inlet 13 can adopt various shapes such as a radial slit shape, a round hole shape, or a combination thereof.

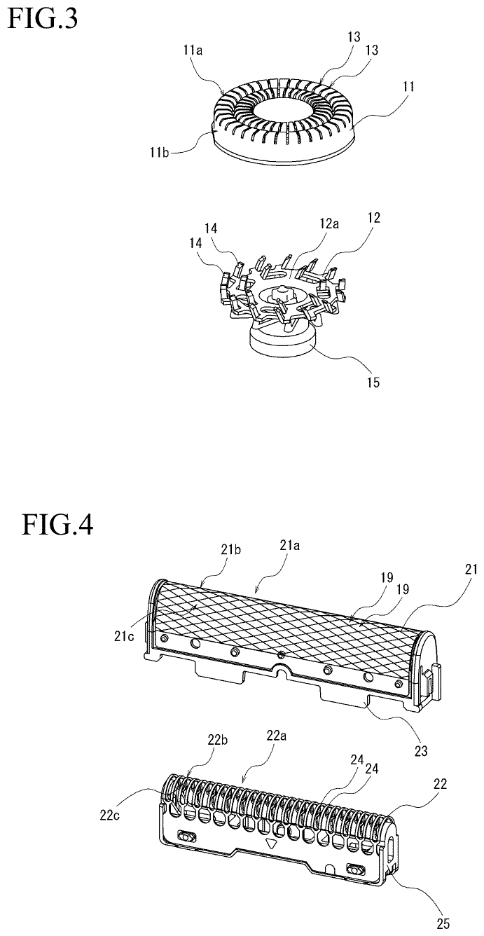

The first inner blade 12 according to the present embodiment is configured to include a plurality of the small blades 14 in which a portion of a flat plate portion 12a is erected with respect to a plate surface by performing processing such as die-cutting and bending through press working by using a flat plate-shaped metal material having a predetermined thickness, which is made of a stainless steel alloy or the like (for simplification of the drawing, reference numerals are assigned only to some of the small blades 14). As an example, as illustrated in FIG. 3, a front end surface of the small blade 14 is formed to be inclined forward in the rotation direction. Therefore, an upper end edge on the front side in the rotation direction serves as a blade edge.

The small blade 14 according to the present embodiment is formed to have the same radial width from an upper end to a lower end. As an example, the small blade 14 has a substantially rectangular prism shape having a rectangular cross section in which the radial width is approximately 1 mm and a circumferential width is approximately 0.5 mm, and is formed to have a length (length from a root to the blade edge) of approximately 3 mm. However, a size and a shape are not limited.

In the present embodiment, the first outer blade 11 has an annular configuration having two rows in the radial direction, and the small blades 14 of the first inner blade 12 corresponding to the first outer blade 11 also has a configuration having two rows in the radial direction, which is a so-called dual-track configuration. However, the configuration is not limited thereto, and may have one row, or three or more rows (not illustrated).

In addition, a driving force transmission member (in the present embodiment, a flexible arm) 16 that transmits a driving force of the motor M to the first inner blade 12 via a gear unit 42 to rotate the first inner blade 12 is provided (refer to FIG. 2). As an example, the first inner blade 12 is fixed to an inner blade mount 15, and the driving force transmission member (flexible arm) 16 is connected to a lower portion of the inner blade mount 15 via a driving pin or the like (not illustrated) (or directly). For example, the “flexible arm” is a member formed in a coil spring shape by using a metal material, and is a rotational force transmission member of which a length and an inclination are variable within a predetermined range (however, the present invention is not limited to this configuration).

An operation for bringing the first inner blade 12 into sliding contact with the first outer blade 11 may be performed by the flexible arm 16, or may be performed by mounting and contracting a spring member (not illustrated) on a driving pin (not illustrated).

Next, the reciprocating-type blade unit 5 will be described. The reciprocating-type blade unit 5 according to the present embodiment includes the second outer blade 21 having a curved arc shape and the second inner blade 22 reciprocating while coming into sliding contact with an inner surface of the second outer blade 21.

In addition, the second outer blade 21 and the second inner blade 22 are attached to a blade frame 20 to be swingable forward, rearward, leftward, and rightward directions and movable upward and downward via a spring member (not illustrated) or the like in a state where both are combined with each other. Furthermore, the blade frame 20 is attached to the head unit 3 or a position below the head unit 3 (may be both positions) so that the blade frame 20 is movable upward and downward.

The second outer blade 21 according to the present embodiment has a configuration in which a flat plate-shaped metal material having a predetermined thickness (relatively thinner than the first outer blade 11 described above), which is made of a stainless steel alloy or the like, is used and curved in an arc shape (arch shape), and is fixed to an outer blade mount 23. Here, the term “arc shape” refers to a reverse U-shape in a cross-sectional view taken along a plane orthogonal to the longitudinal direction. Many hair inlets 19 through which the hairs enter are formed to penetrate an upper surface 21a (specifically, surfaces of a top portion 21b curved in an arc shape and a peripheral portion 21c) of the second outer blade 21 (for simplification of the drawing, reference numerals are assigned only to some of the hair inlets 19). In this manner, an operation is obtained to cut the hairs entering the hair inlet 19 by pinching the hairs between the lower end portion and the tip portion of the second inner blade 22 (small blade 24) (to be described later). The hair inlet 19 can adopt various shapes such as a mesh shape and a round hole shape.

The second inner blade 22 according to the present embodiment has a configuration in which a flat plate-shaped metal material having a predetermined thickness, which is made of a stainless steel alloy or the like, is used and curved in an arc shape (arch shape), that is, in a reverse U shape in a cross-sectional view taken along a plane orthogonal to the longitudinal direction, and is fixed to an inner blade mount 25. As an example, many small blades 24 having an arc shape (arch shape) are integrally formed in the second inner blade 22 (for simplification of the drawing, reference numerals are assigned only to some of the small blades 24). An upper surface 22a (specifically, surfaces of a top portion 22b curved in an arc shape and a peripheral portion 22c) of the second inner blade 22 (small blade 24) is a curved surface that comes into sliding contact with a lower surface (inner surfaces of the top portion 21b and the peripheral portion 21c) of the second outer blade 21.

In addition, the driving force transmission member (oscillator) 26 that transmits the driving force of the motor M to the second inner blade 22 via the gear unit 42 to cause the second inner blade 22 to vibrate (reciprocate) is provided (refer to FIG. 2). In the present embodiment, a configuration is adopted in which a rotational operation of the motor M is converted into a reciprocating operation of an oscillator 26 via a crank shaft 27. As an example, the second inner blade 22 is fixed to the inner blade mount 25, and a driving force transmission member (oscillator) 26 is connected to a lower portion of the inner blade mount 25 via a support member or the like (not illustrated) (or directly). The present invention is not limited to the above-described configuration, and a configuration may be adopted in which the oscillator 26 (that is, the second inner blade 22) is caused to reciprocate by using a linear motor or the like (not illustrated).

An operation for bringing the second inner blade 22 into sliding contact with the second outer blade 21 may be performed by mounting and contracting a spring member on the support member or the like (not illustrated), or may be performed by other configurations (not illustrated).

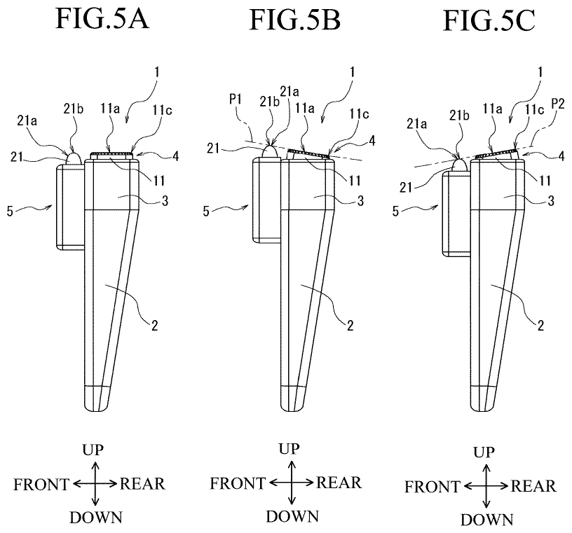

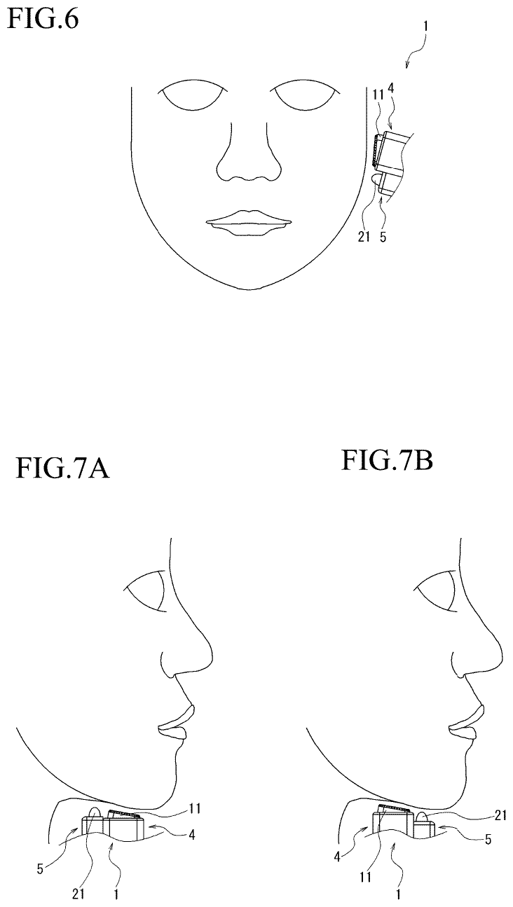

Subsequently, an operation of the electric shaver 1 according to the present embodiment will be described. FIGS. 5A to 5C are views for describing the operations of the respective blade units 4 and 5. In addition, FIGS. 6 to 8 are views for describing a usage state of the electric shaver 1.

First, as illustrated in FIG. 5A, a state where the top portion 21b of the second outer blade 21 (state where the second outer blade 21 is not inclined or moved upward and downward) of the reciprocating-type blade unit 5 and the upper surface 11a of the first outer blade 11 (state where the first outer blade 11 is not inclined or moved upward and downward) of the rotary-type blade unit 4 are located at the same height will be referred to as a “basic state”. Compared to the “basic state”, the reciprocating-type blade unit 5 is configured to be movable upward and downward between a position where the top portion 21b of the second outer blade 21 is higher than the upper surface 11a of the first outer blade 11 and a position where the top portion 21b is lower than the upper surface 11a.

On the other hand, in the “basic state” described above, the rotary-type blade unit 4 is configured such that the upper surface 11a of the first outer blade 11 is inclinable to a position parallel to a tangent plane in contact with a farthest portion 11c from the second outer blade 21 on the upper surface 11a of the first outer blade 11 and the upper surface 21a of the second outer blade 21, even in a case where the top portion 21b of the second outer blade 21 of the reciprocating-type blade unit 5 is located at any position. Specifically, as illustrated in FIG. 5B, when the top portion 21b of the second outer blade 21 is located at a position higher than the upper surface 11a of the first outer blade 11, the upper surface 11a of the first outer blade 11 is configured to be inclinable to a position parallel to a tangent plane P1 in contact with the farthest portion 11c from the second outer blade 21 and the upper surface 21a of the second outer blade 21. In addition, as illustrated in FIG. 5C, when the top portion 21b of the second outer blade 21 is located at a position lower than the upper surface 11a of the first outer blade 11, the upper surface 11a of the first outer blade 11 is configured to be inclinable to a position parallel to a tangent plane P2 in contact with the farthest portion 11c from the second outer blade 21 and the upper surface 21a of the second outer blade 21. The term “parallel” here is not limited to strict parallelism, and includes a slight deviation.

As described above, since the flexible arm 16 that transmits the driving force of the motor M to the first inner blade 12 is provided, it is possible to realize a configuration in which a plurality of sets (two sets in the present embodiment) of the rotary-type blade units 4 are individually inclined (without being in conjunction with each other).

Next, as a specific usage state, a case of using the electric shaver for a cheek will be described with reference to FIG. 6. The cheek is a widest shaving target site on the face and the periphery thereof. Therefore, in the related art, various electric shavers have been developed in which the hairs can be shaved in a shorter time than a configuration including a single (one set) unit by adopting a configuration including a plurality of (for example, two or three sets) rotary-type blade units or a configuration including a plurality of (for example, two to six sets) reciprocating-type blade units. However, as described above, the rotary-type electric shaver has a problem in that deep shaving is difficult although long hairs or curled hairs are easily shaved. On the other hand, the reciprocating-type electric shaver has a problem in that the long hairs or the curled hairs are less likely to be shaved although the deep shaving is easy. In contrast, the electric shaver 1 according to the present embodiment is configured to include both the rotary-type blade unit 4 (two sets) and the reciprocating-type blade unit 5 (one set) as the plurality of blade units. According to this configuration, particularly long hairs or curled hairs can be prevented from being unshaven, and uniform deep shaving can be performed on an entire surface of a shaving target site. In a case of shaving the cheek, it is preferable to use the respective blade units 4 and 5 in a state in FIG. 5C. In this manner, shaving can be performed in a comfortable posture without raising an elbow too much. The blade units may be appropriately used in states in FIGS. 5A and 5B.

In addition, as described above, there is a problem in that the hairs cannot be sufficiently shaved on sites such as a face having a complicated shape, a portion under a chin on the periphery (around a neck), and a portion under a nose. In contrast, according to the electric shaver 1 in the present embodiment, the problem can be solved.

Specifically, a case where the electric shaver is used for the portion under the chin will be described with reference to FIGS. 7A and 7B. In the electric shaver in the related art, particularly when a plurality of blade units are provided, it is difficult to bring the blades (outer blades) into close contact with the portion under the chin having a complicated shape. Therefore, a user has to forcibly adopt a usage method in which the user necessarily faces upward. In contrast, in the electric shaver 1 according to the present embodiment, as illustrated in FIG. 7A, the respective blade units 4 and 5 are used in the above-described state in FIG. 5B. Accordingly, the first outer blade 11 and the second outer blade 21 (particularly, the first outer blade 11) can be easily brought into close contact with the portion under the chin without forcing the user to perform an operation for facing upward. Therefore, the first outer blade 11 can shave the long hairs or the curled hairs without unshaven hairs, and the second outer blade 21 can perform deep shaving to cleanly finish the shaving. As illustrated in FIG. 7B, the respective blade units 4 and 5 are appropriately used in the above-described state in FIG. 5C. Accordingly, shaving for the portion under the chin can be widely, uniformly, and cleanly finished.

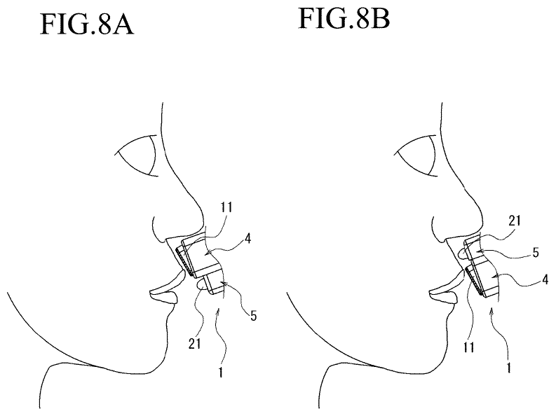

Next, a case of using the electric shaver for a portion under the nose will be described with reference to FIGS. 8A and 8B. In the electric shaver in the related art, particularly when a plurality of blade units are provided, it is difficult to bring the blades (outer blades) into close contact with a portion under the nose having a complicated shape and a narrow width. In contrast, in the electric shaver 1 according to the present embodiment, as illustrated in FIG. 8A, the respective blade units 4 and 5 are used in the above-described state illustrated in FIG. 5C. Accordingly, the first outer blade 11 can be easily brought into close contact with the portion under the nose. Furthermore, as illustrated in FIG. 8B, the respective blade units 4 and 5 are used in the above-described state in FIG. 5B. Accordingly, the second outer blade 21 can be easily brought into close contact with the portion under the nose. Therefore, the first outer blade 11 can shave the long hairs or the curled hairs without unshaven hairs, and the second outer blade 21 can perform deep shaving to cleanly finish the shaving.

### Second Embodiment

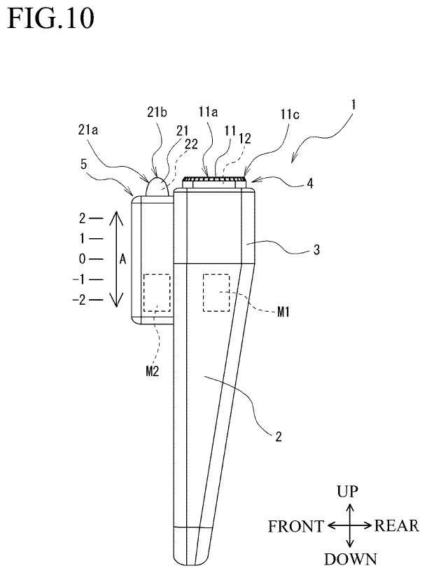

Next, the electric shaver 1 according to a second embodiment of the present invention will be described. The basic configuration is the same as that in the first embodiment. Therefore, different points will be mainly described. FIG. 10 is a schematic view (side view) illustrating an example of the electric shaver 1 according to the present embodiment. Here, an arrow A in FIG. 10 indicates a movement direction (upward and downward movement direction) of the reciprocating-type blade unit 5. In addition, scales marked beside the arrow A are positions set as degrees of the movements of the reciprocating-type blade unit 5. For example, a reference position (central position) is set as a position 0, and the position is set to be movable to positions of two stages (position 1 and position 2) upward and two stages (position-1 and position-2) downward (however, the configuration is not limited thereto). In the present embodiment, even in a case where the top portion 21b of the second outer blade 21 of the reciprocating-type blade unit 5 is located at any position (five positions in the present embodiment), the rotary-type blade unit 4 is provided in the main body 2 to be inclinable to a position where the upper surface 11a of the first outer blade 11 is parallel (not limited to strict parallelism) to a tangent plane in contact with the farthest portion 11c from the second outer blade 21 on the upper surface 11a of the first outer blade 11 and the upper surface 21a of the second outer blade 21. This configuration is the same as that in the first embodiment described above.

In the present embodiment, a motor (first motor) M1 that drives the first inner blade 12 of the rotary-type blade unit 4 and a motor (second motor) M2 that drives the second inner blade 22 of the reciprocating-type blade unit 5 are separately provided, and the rotation speeds can be individually set (in the respective units 4 and 5, when a plurality of units are provided, one motor may be provided in common, or a plurality of motors corresponding to the number of units may be provided).

Furthermore, in the present embodiment, the speeds of the respective inner blades 12 and 22, that is, the rotation speed of the first motor M1 of the rotary-type blade unit 4 and the rotation speed of the second motor M2 of the reciprocating-type blade unit 5 are set to be changed in accordance with (in conjunction with) movement positions (positions) of the reciprocating-type blade unit 5. For example, the rotation speeds are set as illustrated in Table 1 below (however, the configuration is not limited thereto).

TABLE 1
Setting of Each Rotation Speed of Motor Depending on Position

Rotation Speed

| Position | M1 | M2 |
|---|---|---|
| Position 2 | Low | Middle |
| Position 1 | Low | Middle |
| Position 0 | Middle | Middle |
| Position −1 | Middle | High |
| Position −2 | Middle (or High) | High |

Specifically, when a position where the first outer blade 11 and the second outer blade 21 are aligned in a direction orthogonal to the axial direction of the head unit 3, that is, the movement direction (upward and downward movement direction) of the reciprocating-type blade unit 5 is set as a neutral position (position 0), and when the second outer blade 21 is located at a position (positions 1 and 2) higher than the neutral position, the rotation speed of the first motor M1 is set to the rotation speed lower than the rotation speed of the first motor M1 at the neutral position while the rotation speed of the second motor M2 is maintained. In addition, when the second outer blade 21 is located at the position (positions-1 and -2) lower than the neutral position, the rotation speed of the second motor M2 is set to the rotation speed higher than the rotation speed of the second motor M2 at the neutral position while the rotation speed of the first motor M1 is maintained.

According to this configuration, shaving can be performed at an optimum position (optimum rotation speeds of the respective motors M1 and M2, that is, optimum speeds of the respective inner blades 12 and 22), depending on a site of the face having a complicated shape. As an example, since the cheek has relatively skin tension and the skin is not likely to sag, the position-1 and position-2 can be selected to perform shaving in which cutting quality is emphasized. As another example, since the skin of the portion under the chin is likely to sag, the positions 1 and 2 can be selected to perform shaving in which damage to the skin is suppressed.

As described above, according to the electric shaver 1 in the present invention, it is possible to realize a cleanly finished state by preventing the long hairs or the curled hairs from being unshaven and enabling uniform deep shaving to be performed on an entire surface of a shaving target site for the face having a complicated shape and peripheral sites.

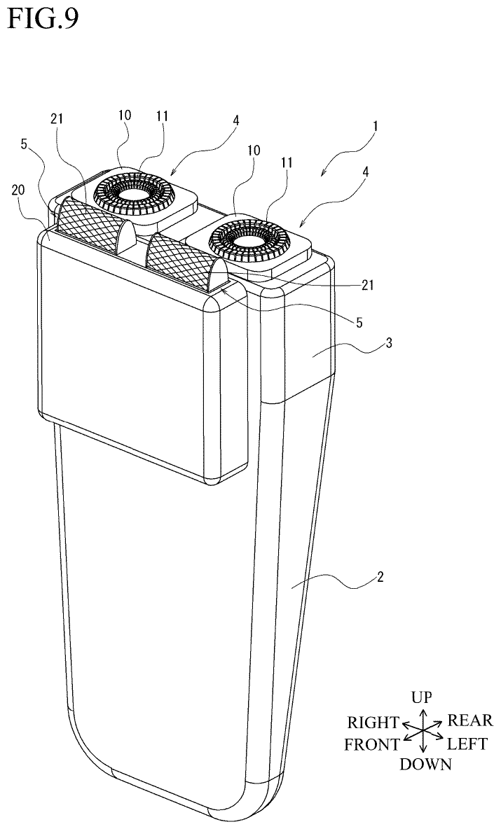

The present invention is not limited to the embodiments described above, and various modifications can be made within the scope not departing from the present invention. For example, a configuration may be adopted in which two sets of the rotary-type blade units 4 and two sets of the reciprocating-type blade units 5 are provided. Specifically, as illustrated in FIG. 9, two sets of the reciprocating-type blade units 5 are provided such that at least the second outer blades 21 have the same width (width in a short direction) and the upper surfaces have the same height. The two sets of the reciprocating-type blade units 5 are configured to be aligned in series such that respective center lines of the second outer blades 21 in the longitudinal direction (that is, lines parallel to the longitudinal direction and orthogonal to the center in the short direction) in a plan view are on the same line. According to this configuration, furthermore, an advantageous effect of causing the second outer blade 21 of the reciprocating-type blade unit 5 to follow the skin can be enhanced. Therefore, the above-described advantageous effect of the present invention can be further enhanced.

What is claimed is:

1. An electric shaver comprising:
a main body including
a rotary-type blade unit having a first outer blade having an annular shape or a disk shape, and a first inner blade rotating while coming into sliding contact with an inner surface of the first outer blade;
a reciprocating-type blade unit having a second outer blade having a curved arc shape, and a second inner blade reciprocating while coming into sliding contact with an inner surface of the second outer blade; and
a motor,
wherein the reciprocating-type blade unit is provided in the main body such that the second outer blade is movable upward and downward, and
even in a case where a top portion of the second outer blade is located at any position, the rotary-type blade unit is provided in the main body such that an upper surface of the first outer blade is inclinable to a position parallel to a tangent plane in contact with a farthest portion from the second outer blade on the upper surface of the first outer blade and an upper surface of the second outer blade.

2. The electric shaver according to claim 1, wherein the rotary-type blade units are provided in two sets, and are disposed such that a line connecting respective centers of the two sets in a plan view is parallel to a longitudinal direction of the reciprocating-type blade unit.

3. The electric shaver according to claim 2, further comprising:
a flexible arm that transmits a driving force of the motor to the first inner blade.

4. The electric shaver according to claim 1, wherein the reciprocating-type blade units are provided in two sets, and are disposed in series such that respective center lines of the two sets in a longitudinal direction in a plan view are located on the same line.

5. The electric shaver according to claim 2, wherein the reciprocating-type blade units are provided in two sets, and are disposed in series such that respective center lines of the two sets in a longitudinal direction in a plan view are located on the same line.

6. The electric shaver according to claim 3, wherein the reciprocating-type blade units are provided in two sets, and are disposed in series such that respective center lines of the two sets in a longitudinal direction in a plan view are located on the same line.

7. The electric shaver according to claim 1, further comprising:
a first motor that drives the first inner blade of the rotary-type blade unit; and
a second motor that drives the second inner blade of the reciprocating-type blade unit.

8. The electric shaver according to claim 7, wherein a rotation speed of the first motor and a rotation speed of the second motor are set to be changed depending on a position of the reciprocating-type blade unit in upward and downward directions.
